(19) United States
(12) Patent Application Publication
(10) Pub. No.: US 2017/0321898 A1
(43) Pub. Date: Nov. 9, 2017

(54) SMART FURNACE

(71) Applicant: Ryan Sean Randell, Minesing (CA)

(72) Inventor: Ryan Sean Randell, Minesing (CA)

(21) Appl. No.: 15/147,869

(22) Filed: May 5, 2016

(51) Int. Cl. F23N 5/24; F24D 19/10; G08C 17/02

(52) U.S. Cl. CPC F23N 5/242; G08C 17/02; F24D 19/10; G08C 2201/00

(57) ABSTRACT

A furnace a smart furnace monitoring system, comprising: a) a wireless communication module; and b) a control module in communication with the wireless communication module, wherein the wireless communication module is capable of sending one or more status information messages to one or more recipients via a network.

### FIELD OF THE INVENTION

The present disclosure is in the field of a smart furnaces and smart furnace monitoring systems.

### BACKGROUND OF THE DISCLOSURE

When a home or business owner installs a furnace on a property there is a chance that over some period of time that the furnace may have a malfunction. For example, a fault code can cause an outage or malfunction, or a failed furnace in winter months can cause the temperatures inside the property to fall below freezing and damage the interior. In these circumstances the owner is often dependent on a technician scheduling a time to visit the installation at the owner's property causing significant time and delay in correction the issue.

Therefore, a need exists for a cost effective smart furnace that can communicate with the absent property owner and/or a technician about changes in the functioning status of the smart furnace and in some instances correct a malfunction remotely.

### SUMMARY OF THE INVENTION

Disclosed herein is a furnace comprising smart furnace monitoring system, comprising: a) a wireless communication module; and b) a control module in communication with the wireless communication module, wherein the wireless communication module is capable of sending one or more status information messages to one or more recipients via a network.

In another aspect, disclosed herein is a smart furnace monitoring system comprising: a) a wireless communication module; and b) a control module in communication with the wireless communication module, wherein the wireless communication module is capable of sending one or more status information messages to one or more recipients via a network.

In still another aspect, disclosed herein is a method of monitoring the status of a furnace comprising a smart furnace monitoring system, comprising: a) a wireless communication module; and b) a control module in communication with the wireless communication module, wherein the wireless communication module is capable of sending one or more status information messages to one or more recipients via a network, the method comprising: a) transmitting at least one status information message from a wireless communication module to at least one computer or mobile phone via a network; b) receiving the at least one status information message from step a) via a network by a computer or a mobile phone; and c) processing the received status information from step b).

### BRIEF DESCRIPTION OF THE DRAWINGS

FIG. 1 is an illustration of a smart furnace installation 100 in a building comprising a smart furnace 140 and wireless remote communication pathway 114 over a network 118.

FIG. 2 is an illustration of a wall mounted smart furnace monitoring system comprising a control module 102 and a WiFi™ communication module 106.

FIG. 3 is an illustration of a smart furnace mounted smart furnace monitoring system comprising a control module 132 and a WiFi™ communication module 126.

FIG. 4 illustrates a schematic block diagram of a conceptual computer system 400 used to implement some embodiments. For example, the system described with reference to the disclosure and Figures herein may be at least partially implemented using computer system 400.

### DETAILED DESCRIPTION OF THE EMBODIMENTS

The following is a detailed description of certain specific embodiments of the smart furnace and smart furnace monitoring systems and methods disclosed herein.

In one aspect, disclosed herein is a furnace comprising smart furnace monitoring system, comprising: a) a wireless communication module; and b) a control module in communication with the wireless communication module, wherein the wireless communication module is capable of sending one or more status information messages to one or more recipients via a network, and wherein the one or more status information messages are selected from the group consisting of fault codes, error messages and/or safety warnings.

Disclosed herein are smart furnaces and smart furnace monitoring systems that monitor one or more status conditions within an installation, for example, a home, a business, a car garage, a shed, a mobile unit, and the like. When the status condition shows a fault code, malfunction, etc., the smart furnace sends an electronic message, such as an email, a text, a pre-recorded phone message, to a contact person or recipient, relaying the change in the status condition for the smart furnace. Moreover, the electronic messages may comprise instructions to an owner or user detailing a solution to a fault code.

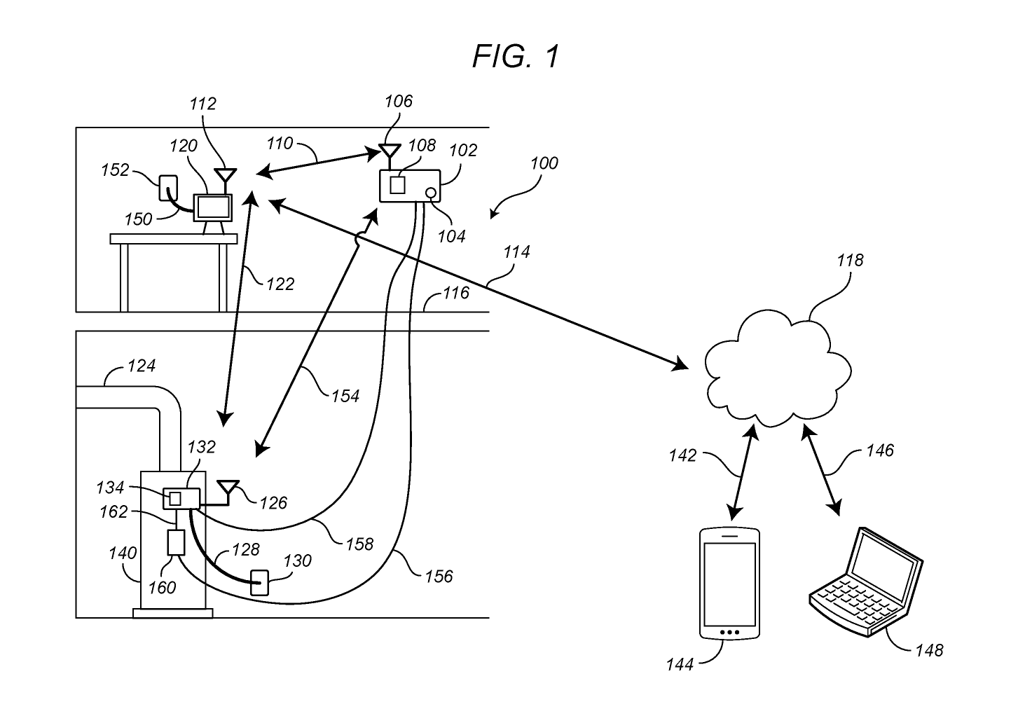

Turning to the drawings, FIG. 1 depicts a smart furnace 140 comprising a vent 124, control module 132, display and/or touchscreen display 134, wireless module 126 and a wireless remote communication pathway 122. In some embodiments, the smart furnace monitoring system is located either affixed to smart furnace or affixed to an interior wall of a building 116. In some embodiments, the smart furnace may be connected to a network via an Ethernet cable 128 using an Ethernet wall adaptor 130. In some embodiments, the wireless communications module 126 uses WiFi™ communications over a network 118. The smart furnace installation 100 of FIG. 1, comprises a wireless communications module 126 in communication with a home or business WiFi™ router 120 and/or WiFi™ antenna 112 which may be in communication with a network 118 via an Ethernet cable 150 via a wall adaptor 152. In some embodiments, the smart furnace may comprise a furnace mounted control module 132 or alternatively may comprise a wall mounted control module 102 which may also comprise a display and/or touchscreen display 108, wireless module 106 and a wireless remote communication pathway 110 and/or communication pathway 154. Communications to recipients may occur over a network 118 whereby communications can be transmitted and received to a recipient's mobile phone 144 and/or computer 148 via communication pathways 142 and 146, respectively. Other configurations may include a wired connection from a wall mounted control module 102 via wired connection 158 or between a wall mounted control module 102 and furnace circuit board 160 via wired connection 156. In some embodiments, furnace circuit board 160 is in electrical communication with a furnace mounted control module 132 via circuit board connection 162. In some embodiments, the furnace uses wireless technology and a computer present in a building where the furnace is installed to send an email notification to one or more predetermined email addresses. In some embodiments, the wireless communication module further comprises sending an email to a user, owner and/or a furnace technician. In some embodiments, the wireless communication module further comprises sending a text message, an e-mail, a Twitter post, a prerecorded phone message to a property owner, user, furnace technician, emergency services, fire department, insurance company, or any other specified recipient.

The smart furnace utilizes fuels common with residential and/or commercial furnace installations such as natural gas, propane, electric, oil, or wood. In some embodiments, the smart furnace utilizes one or more biofuels, biomass or fuels suitable for residential and/or commercial furnace installations. Moreover, the smart furnace disclosed herein employs components employed with residential and/or commercial furnace installations. For example, the smart furnace discloses herein comprises one or more burners, gas control valve, an igniter, flame sensor, pressure switch, flame roll out switch, high limit temperature switch, an inducer motor, blower motor, primary heat exchanger, secondary heat exchanger, condensate trap, transformer, circuit Board, fan control board, door interlock switch, ignition control, air intake, and/or exhaust module.

When the status information shows a malfunction, fault code, error, etc. for one or more of the smart furnace components, the control module triggers the wireless communications module for a message to be sent to a user, owner, furnace technician and/or preselected recipients. The message can be in the form of an email message, text message, an e-mail, a Twitter post, a prerecorded phone message, and the like. The user inputs the contact information for the intended recipient(s) of the message into the control module or via a mobile phone application or computer application. In some embodiments, the intended recipient is the property owner. In other embodiments, the intended recipient is an agent of the property owner who is tasked with overseeing the property in the owner's absence. In still other embodiments, the intended recipient is a furnace technician, emergency services, or the insurance company. In one embodiment, the device uses wireless technology and a computer present in the building to send an email notification to predetermined email addresses. In one embodiment, the device uses wireless technology to send a text message notification to predetermined cell phones. In some embodiments, multiple intended recipients receive the message(s).

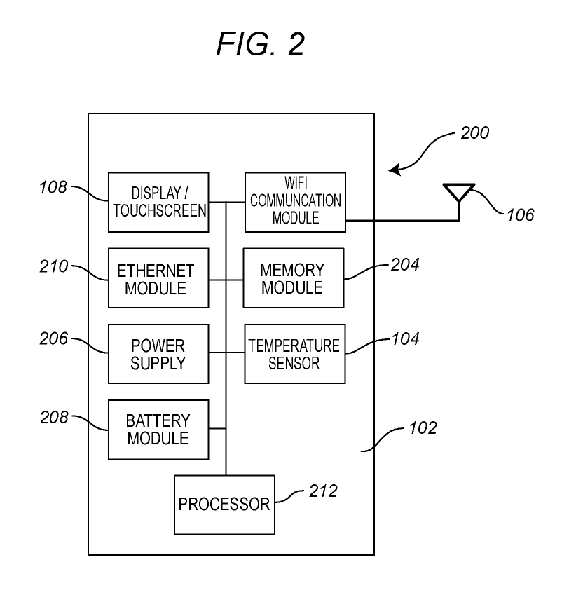

Turning to FIG. 2, the wall mounted smart furnace monitoring system installation 200 comprises a wall mounted control module 102. The wall mounted control module 102 may comprise a WiFi™ communications module 106, memory module 204, temperature sensor 104, processor 212, Ethernet module 210, battery module 208, power supply 206 and a display and/or touchscreen display 108. In some embodiments, the control module further comprises an LCD display for displaying the temperature and status information. In some embodiments, the control module further comprises a power source. In some embodiments, the control module is capable of sending status information to one or more users when a backup battery life is low. In some embodiments, the control module 102 is capable of sending status information to one or more users when a carbon monoxide levels are above acceptable levels and may be in electrical communication with one or more smoke detectors and/or carbon monoxide detectors.

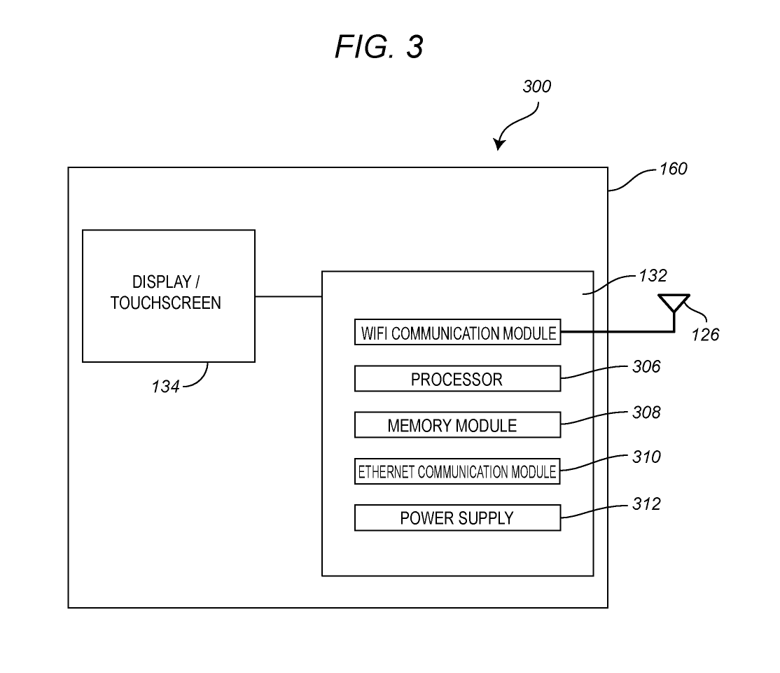

Turning to FIG. 3, the furnace mounted smart furnace monitoring system installation 300 comprises a furnace mounted control module 132. The furnace mounted control module 132 may comprise a WiFi™ communications module 126, memory module 308, processor 306, Ethernet module 310, power supply 312 and a display and/or touchscreen display 134. In some embodiments, the control module further comprises an LCD display for displaying the temperature and status information. In some embodiments, the control module further comprises a power source. In some embodiments, the control module is capable of sending status information to one or more users when a backup battery life is low. In some embodiments, the control module 132 is capable of sending status information to one or more users when a carbon monoxide levels are above acceptable levels and may be in electrical communication with one or more smoke detectors and/or carbon monoxide detectors.

In some embodiments, the control module is capable of transmitting and retrieving diagnoses information via the wireless communication module to/from the one or more recipients. In some embodiments, the smart furnace further comprises a diagnoses module capable of receiving and transmitting diagnoses information to/from the control module. In some embodiments, the control module further comprises a thermostat. In some embodiments, the control module in communication with the wireless communication module allows a user or a technician to monitor and adjust a smart furnace's settings remotely using a remote computer application or a mobile phone application.

In another aspect, disclosed herein is a smart furnace monitoring system comprising: a) a wireless communication module; and b) a control module in communication with the wireless communication module, wherein the wireless communication module is capable of sending one or more status information messages to one or more recipients via a network, and wherein the one or more status information messages are selected from the group consisting of fault codes, error messages and/or safety warnings. In some embodiments, the control module is capable of transmitting and retrieving diagnoses information via the wireless communication module to/from the one or more recipients. In some embodiments, the smart furnace monitoring system further comprises a diagnoses module capable of receiving and transmitting diagnoses information to/from the control module. In some embodiments, the control module is located either affixed to smart furnace or affixed to an interior wall of a building. In some embodiments, the smart furnace monitoring system wherein the control module further comprises a thermostat. In some embodiments, the wireless communication module further comprises sending a text message, an e-mail, a Twitter post, a prerecorded phone message to a property owner, user, furnace technician, emergency services, fire department, insurance company, or any other specified recipient. In some embodiments, the control module in communication with the wireless communication module allows a user or a technician to monitor and adjust a smart furnace's settings remotely using a remote computer application or a mobile phone application.

In another aspect, disclosed herein is a method of monitoring the status of a furnace comprising a smart furnace monitoring system comprising: a) transmitting at least one status information message from a smart furnace's wireless communication module to at least one computer or mobile phone via a network; b) receiving the at least one status information message from step a) via a network by a computer or a mobile phone; c) processing the received status information from step b); and diagnosis of at least one furnace fault code, error message and/or safety warning.

In yet another aspect, disclosed herein is a method of monitoring the status of a furnace comprising a smart furnace monitoring system comprising: a) transmitting at least one status information message from a smart furnace's wireless communication module to at least one computer or mobile phone via a network; b) receiving the at least one status information message from step a) via a network by a computer or a mobile phone; c) processing the received status information from step b); d) transmitting at least one command message from the computer or mobile phone to the smart furnace; e) receiving at least one command message from a smart furnace's wireless communication module; and f) processing at least one command message from a smart furnace's control module.

In some embodiments, the method of monitoring the status of a furnace further comprises a step of diagnosis of at least one furnace fault code, error message and/or safety warning. In some embodiments, the method of monitoring the status of a smart furnace further comprises a step of transmitting a message to a user to provide furnace service status updates via a mobile phone and/or computer from a furnace technician. In some embodiments, the method of monitoring the status of a smart furnace further comprises a user and/or a furnace technician may remotely diagnose and correct furnace malfunctions, fault code, error message and/or safety warning remotely via a computer network.

### Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be adapted to perform functions and/or features that may be associated with various software elements described throughout.

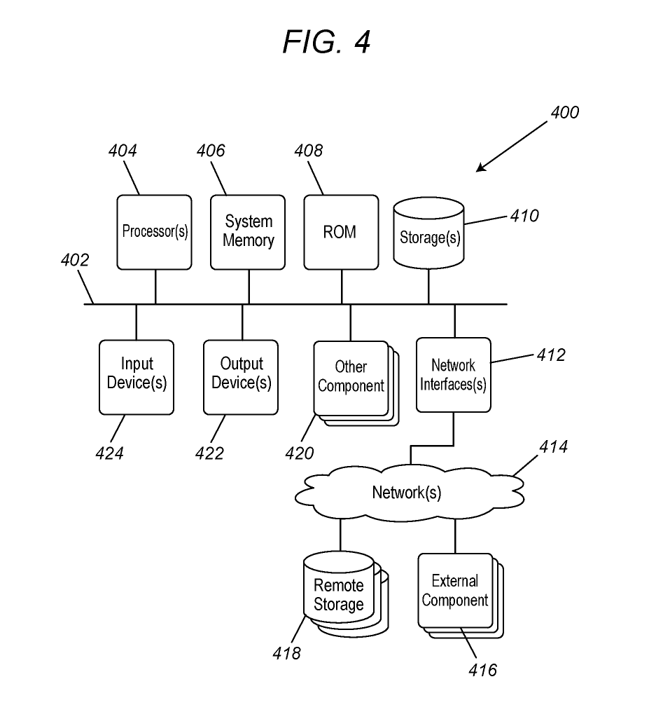

Referring to the drawings, FIG. 4 illustrates a schematic block diagram of a conceptual computer system 400 used to implement some embodiments. For example, the system described above in reference to FIGS. 1-3 may be at least partially implemented using all or a portion of computer system 400.

Computer system 400 may be implemented using various appropriate devices. For instance, the computer system may be implemented using one or more vehicle display units, personal computers (PCs), servers, mobile devices (e.g., a smartphone), tablet devices, and/or any other appropriate devices. The various devices may work alone (e.g., the computer system may be implemented as a vehicle display unit) or in conjunction (e.g., some components of the computer system may be provided by a vehicle display unit while other components may be provided by a tablet device).

As shown, computer system 400 may include at least one communication bus 402, one or more processors 404, a system memory 406, a read-only memory (ROM) 408, permanent storage devices 410, input devices 424, output devices 422, various other components 420 (e.g., a graphics processing unit), and one or more network interfaces 412 and may include a network 414, corresponding remote storage 418 and a corresponding external component 416.

Communication bus 402 represents all communication pathways among the elements of computer system 400. Such pathways may include wired, wireless, optical, and/or other appropriate communication pathways. For example, input devices 424 and/or output devices 422 may be coupled to the system 400 using a wireless connection protocol or system.

The processor 404 may, in order to execute the processes of some embodiments, retrieve instructions to execute and/or data to process from components such as system memory 406, ROM 408, and permanent storage device 410. Such instructions and data may be passed over bus 402.

System memory 406 may be a volatile read-and-write memory, such as a random access memory (RAM). The system memory may store some of the instructions and data that the processor uses at runtime. The sets of instructions and/or data used to implement some embodiments may be stored in the system memory 406, the permanent storage device 410, and/or the read-only memory 408. ROM 408 may store static data and instructions that may be used by processor 404 and/or other elements of the computer system.

Permanent storage device 410 may be a read-and-write memory device. The permanent storage device may be a non-volatile memory unit that stores instructions and data even when computer system 400 is off or unpowered. Computer system 400 may use a removable storage device and/or a remote storage device as the permanent storage device.

Input devices 424 may enable a user to communicate information to the computer system and/or manipulate various operations of the system. The input devices may include keyboards, cursor control devices, audio input devices and/or video input devices. Output devices 422 may include printers, displays, and/or audio devices. Some or all of the input and/or output devices may be wirelessly or optically connected to the computer system.

Other components 420 may perform various other functions. These functions may include performing specific functions (e.g., graphics processing, sound processing, etc.), providing storage, interfacing with external systems or components, etc.

Referring to FIG. 4, computer system 400 may be coupled to one or more networks 414 through one or more network interfaces 412. For example, computer system 400 may be coupled to a web server on the Internet such that a web browser executing on computer system 400 may interact with the web server as a user interacts with an interface that operates in the web browser. Computer system 400 may be able to access one or more remote storages 418 and one or more external components 416 through the network interface 412 and network 414. The network interface(s) 412 may include one or more application programming interfaces (APIs) that may allow the computer system 400 to access remote systems and/or storages and also may allow remote systems and/or storages to access computer system 400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict any definitions in this disclosure.

What is claimed is:

1. A furnace comprising a smart furnace monitoring system, comprising:
a) a wireless communication module; and
b) a control module in communication with the wireless communication module,
wherein the wireless communication module is capable of sending one or more status information messages to one or more recipients via a network.

2. The furnace of claim 1, wherein the one or more status information messages are selected from the group consisting of fault codes, error messages and/or safety warnings.

3. The furnace of claim 1, wherein the smart furnace monitoring system is capable of transmitting and retrieving diagnoses information via the wireless communication module to/from the one or more recipients.

4. The furnace of claim 1, further comprises a diagnoses module capable of receiving and transmitting diagnoses information to/from the control module.

5. The furnace of claim 1, wherein the smart furnace monitoring system is located either affixed to smart furnace or affixed to an interior wall of a building.

6. The furnace of claim 1, wherein the control module further comprises a thermostat.

7. The furnace of claim 1, wherein the furnace uses wireless technology and a computer present in a building where the furnace is installed to send an email notification to one or more predetermined email addresses.

8. The furnace of claim 1, wherein the wireless communication module further comprises sending a text message, an e-mail, a Twitter post, a prerecorded phone message to a property owner, user, furnace technician, emergency services, fire department, insurance company, or any other specified recipient.

9. The furnace of claim 1, wherein the control module further comprises an LCD display for displaying the temperature and status information.

10. The furnace of claim 1, wherein the control module further comprises a power source.

11. The furnace of claim 1, wherein the control module is capable of sending status information to one or more users when a backup battery life is low.

12. The furnace of claim 1, wherein the control module in communication with the wireless communication module allows a user or a technician to monitor and adjust a furnace's settings remotely using a remote computer application or a mobile phone application.

13. A furnace monitoring system comprising:
c) a wireless communication module; and
d) a control module in communication with the wireless communication module,
wherein the wireless communication module is capable of sending one or more status information messages to one or more recipients via a network.

14. The furnace monitoring system of claim 13, wherein the one or more status information messages are selected from the group consisting of fault codes, error messages and/or safety warnings.

15. The furnace monitoring system of claim 13, wherein the control module is capable of transmitting and retrieving diagnoses information via the wireless communication module to/from the one or more recipients.

16. The furnace monitoring system of claim 13, further comprises a diagnoses module capable of receiving and transmitting diagnoses information to/from the control module.

17. The furnace monitoring system of claim 13, wherein the smart furnace monitoring system is located either affixed to smart furnace or affixed to an interior wall of a building.

18. The furnace monitoring system of claim 13, wherein the control module further comprises a thermostat.

19. The furnace monitoring system of claim 13, wherein the wireless communication module further comprises sending a text message, an e-mail, a Twitter post, a prerecorded phone message to a property owner, user, furnace technician, emergency services, fire department, insurance company, or any other specified recipient.

20. The furnace monitoring system of claim 13, wherein the control module in communication with the wireless communication module allows a user or a technician to monitor and adjust a furnace's settings remotely using a remote computer application or a mobile phone application.
